(19) United States
(12) Patent Application Publication
(10) Pub. No.: US 2016/0322080 A1
(43) Pub. Date: Nov. 3, 2016

(54) Unified Processing of Multi-Format Timed Data

(71) Applicant: Microsoft Technology Licensing, LLC, Redmond, WA (US)

(72) Inventors: Marcin Stankiewicz, Redmond, WA (US); Stephen J. Estrop, Carnation, WA (US); Bala Sivakumar, Sammamish, WA (US); Haishan Zhong, Redmond, WA (US)

(21) Appl. No.: 14/700,810

(22) Filed: Apr. 30, 2015

(51) Int. Cl. G11B 27/10; G11B 27/32; G11B 27/036; H04N 5/85

(52) U.S. Cl. CPC G11B 27/105; H04N 5/85; G11B 27/32; G11B 27/036

(57) ABSTRACT

A timed data component is implemented within an operating system to provide parsing and data conversion of multiple timed data formats. The timed data component supports multiple formats of closed caption data and timed metadata, generating structured cue objects that include the data and timing information. Applications using proprietary or non-supported formats can pre-format the timed data as structured cue objects before sending the timed data to the timed data component. Structured cue objects output from the timed data component may be processed by a single text renderer to provide a consistent look and feel to closed caption data originating in any of multiple formats.

### BACKGROUND

Video content is available from a variety of sources and is consumable via a variety of devices, including, for example, televisions, laptop or desktop computers, tablet computers, mobile phones, etc. Often times, video content has associated therewith timed data that can be rendered (or otherwise processed) in synchronization with the video content, such as closed caption text. Closed caption data may be provided in any of a variety of formats, which vary in feature set, capabilities, and richness of describing the information to be displayed.

In existing systems, each video application is responsible for providing support for closed caption data. This typically includes a format-specific parser and a format-specific renderer for each closed caption data format supported by the application. Because each application includes its own renderer(s), and each renderer is format-specific, the look and feel of rendered closed caption text may differ depending on which format was used for the closed caption data, and thus, which renderer was used to render the closed caption text. For example, closed caption text received in a first format and rendered through a video application may look different from closed caption text received in a different format and rendered through the same video application, even though both may be specified to have the same font, size, and color.

### SUMMARY

Unified processing of multi-format timed data is described herein. Closed caption text or timed metadata is processed through an operating system-level timed data component that includes support for multiple timed data formats. The timed data component generates structured cue objects that include both the timed data and the timing information. A text renderer, also implemented as a component of the operating system, receives a cue object when the timing information of the cue object corresponds to video content being rendered by a video renderer. In response, the text renderer renders the timed text data.

### BRIEF DESCRIPTION OF THE DRAWINGS

The same numbers are used throughout the drawings to reference like features and components.

FIG. 1 is a block diagram of an example environment in which unified processing of multi-format timed data is implemented.

FIG. 2 is a block diagram illustrating example data flow when a media source provides video content with out-of-band closed caption data.

FIG. 3 is a block diagram illustrating example data flow when a media source provides video content with in-band closed caption data.

FIG. 4 is a block diagram illustrating an example data flow when a media source provides video content with embedded closed caption data.

FIG. 5 is a block diagram of selected components of an example computing device implementing unified processing of multi-format timed data.

FIG. 6 is a flow diagram of an example method for processing multi-format timed data.

### DETAILED DESCRIPTION

The following discussion is directed to unified processing of multi-format timed data associated with video content. Various formats exist for providing closed caption data in conjunction with video content. Rather than requiring each application to include its own closed caption data parser and closed caption renderer, for each closed caption format to be supported by the application, in the described example embodiments, the timed data component is implemented as a component of the operating system, making it accessible to any number of applications. The timed data component receives closed caption data in any of a number of supported closed caption formats, and generates a cue object having a data structure readable by a text renderer. As a result, in some examples, a single timed data component and a single renderer support closed caption data received in a variety of formats. The timed data component is also extensible, allowing for expansion to support conversion of additional, even yet to be created, closed caption formats. Furthermore, the timed data component provides support for custom closed caption formats and for other timed metadata. For example, an application may use a proprietary closed caption format. In this scenario, the application can be configured to pre-format the closed caption data according to the data structure of the cue object before sending the closed caption data to the timed data component, enabling the application to still utilize the single text renderer, even though the application's closed caption data is not in a closed caption format specifically supported by the timed data component. As another example, timed metadata, such as binary application-specific data, can also be passed through the timed data component, for example, for processing by the application.

The timed data component described herein supports use of a single text renderer, thereby providing a consistent look and feel of closed caption data, regardless of the format in which the closed caption data was originally created. In addition, the single timed data component, which supports a single text renderer, reduces the complexity of applications that present video content, by eliminating the need for each application to provide its own timed text data parsers and text renders for each closed caption format the application supports. Furthermore, applications that utilize a custom or otherwise non-supported format can pre-parse the data before sending it to the timed text component, which allows an application to maintain consistent look and feel through the use of the centralized text renderer. Other timed metadata such as, for example, ID3 data, which is a well-known identification tagging format, can also be passed through the timed text component, without parsing. Metadata that is passed through the timed text component is then available to the application. In an example, an application can implement business logic based on the metadata. For example, based on received ID3 data, an application can keep track of which portions of a media content file have been played, can display side-loaded content (e.g., targeted ads, actor biographies, etc.) related to video content being played.

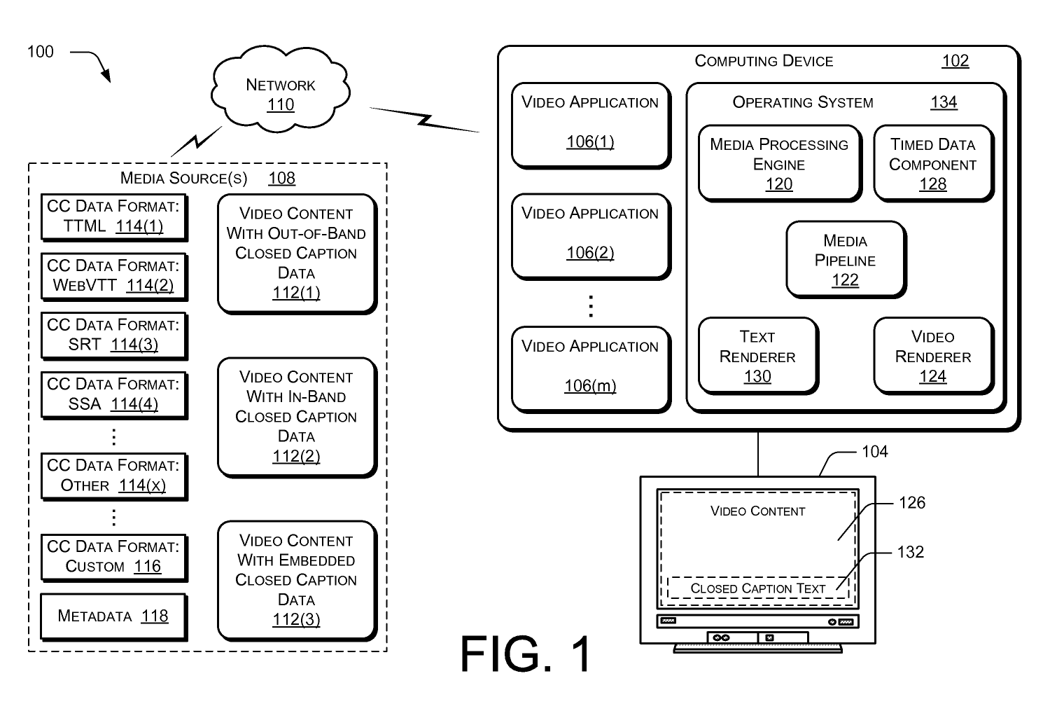

FIG. 1 illustrates an example environment 100 in which a timed data component supports multiple closed caption data formats. In the illustrated example, environment 100 includes a computing device 102, which includes, or is communicatively coupled to, a display device 104. Computing device 102 represents any type of device that can receive and present video content. Computing device 102 may be implemented as, for example, but without limitation, an Internet-enabled television, a television set-top box, a game console, a desktop computer, a laptop computer, a tablet computer, or a smartphone. Computing device 102 includes any number of video applications, such as video applications 106(1), 106(2), . . . , 106(m). Each video application 106 represents an application through which a user can view video content. Video applications 106 may include, for example, an internet browser, a television viewing application, a streaming video application, a video editing application, and so on.

A video application 106 accesses a media source 108 to obtain video content, which may have associated closed caption data. For example, a video application 106 may access a media source 108 via a network 110, such as the Internet. Alternatively, a media source 108 may be local to computing device 102, such as a file stored in a memory of the computing device or a digital video disc (DVD) in a DVD drive of the computing device 102. Network 110 can include a cable television network, radio frequency (RF), microwave, satellite, and/or data network, such as the Internet, and may also support wired or wireless media using any format and/or protocol, such as broadcast, unicast, or multicast. Additionally, network 110 can be any type of network, wired or wireless, using any type of network topology and any network communication protocol, and can be represented or otherwise implemented as a combination of two or more networks.

Media source 108 may provide access to video content that has various types of associated closed caption data and/or metadata. For example, media source 108 may provide any one or more of video content 112(1), which has associated out-of-band closed caption data, video content 112(2), which has associated in-band closed caption data, and/or video content 112(3), which has embedded closed caption data. As used herein, out-of-band closed caption data is delivered in a separate file distinct from a file containing the video content, in-band closed caption data is delivered as a separate track within a file that includes the video content, and embedded closed caption data is embedded within the frames of the video content.

In addition to the various ways in which closed caption data can be delivered, a variety of formats exist for closed caption data. For example, closed caption data formats may include, but are not limited to, TTML 114(1), WebVTT 114(2), SRT 114(3), SSA 114(4), and any other known closed caption data format 114(x). In addition, an application may provide closed caption data in a proprietary custom format 116. Furthermore, in addition to closed caption data, video content may include other metadata, represented in FIG. 1 as metadata 118. Examples of other metadata 118 include, without limitation, targeted advertisements, actor biographies, ID3 data, and so on.

When a video application 106 obtains video content 112 from a media source 108, the video application 106 calls media processing engine 120. Media processing engine 120 drives media pipeline 122 to decode and process the video content, preparing the video content for video renderer 124. Video renderer 124 renders the video content 126 for display via display device 104. Timed data component 128 parses closed caption data received in conjunction with the video content. Timed data component 128 generates a cue object based on the closed caption data, and sends the cue object to text renderer 130. Text renderer 130 renders the closed caption text 132 for display via display device 104. In an example implementation, metadata 118 may be passed through the timed data component 128 without being parsed.

In the illustrated example environment 100, media processing engine 120, media pipeline 122, video renderer 124, timed data component 128, and text renderer 130 are each components of operating system 134. However, in other examples one or more of the system components may be implemented a part of a distributed system, for example, as part of a cloud-based service or as components of another application. For example, a timed data component may be implemented as a system separate from the media pipeline, through which, data may be parsed separately and then rendered over the video based on time events received from the media processing engine. As another example alternative, the timed data component and the renderer may be implemented as components of the media pipeline. In this scenario, the media pipeline may decode the image, and draw the text on the video frame before the video frame is rendered for display on the screen. As yet another example alternative, timed data component may be implemented as part of a cloud-based service. In this scenario, the cloud-based service may receive the video content and the timed data. The cloud-based service may then output a media file that includes closed caption text burned into the video, such that there would be no need for the client device to include a timed text component to process closed caption data.

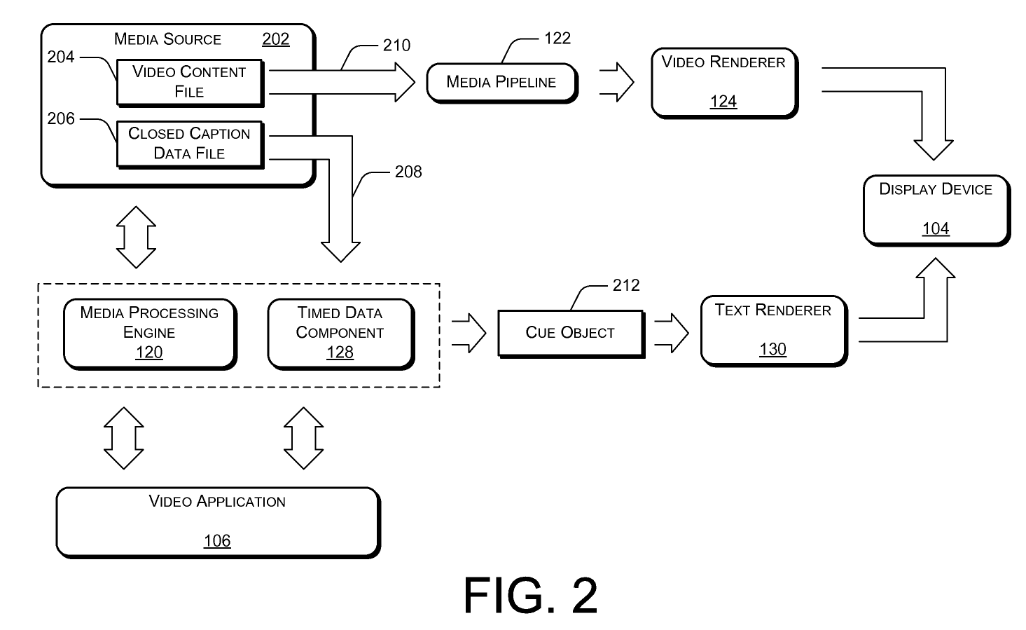

FIG. 2 illustrates an example data flow when a media source provides video content with out-of-band closed caption data. In the illustrated example, a video application 106 communicates with media processing engine 120 and timed data component 128 to identify media source 202. For example, a user may request, through a user interface of video application 106, to view a particular video content. The video application 106 sends the location of the requested video content to the media processing engine 120 and/or the timed data component 128 to identify the media source 202. A media source may be identified, for example, as a URL or a local file location. Alternatively, the video application 106 may download, access, or generate the video content, and provide the media processing engine 120 and timed data component 128 with a stream of data (e.g., media source 202) from which the media processing engine 120 and/or timed data component 128 can pull the video content and/or closed caption data. Media source 202 includes a video content file 204 and an associated closed caption data file 206. Because the closed caption data is provided as a separate file (out-of-band), the closed caption data file 206 is sent directly to the timed data component 128, as indicated by arrow 208. Substantially simultaneously, the video content file 204 is sent to the media pipeline 122, as indicated by arrow 210. The video content is processed in the media pipeline and output to the video renderer 124, which prepares the video content for presentation via display device 104.

Upon receiving the closed caption data file 206, timed data component 128 determines the format of the closed caption data, performs the appropriate data parsing and data conversion, and generates cue object 212. Timed data component 128 sends the cue object 212 to the text renderer 130, which prepares the closed caption text for presentation via display device 104.

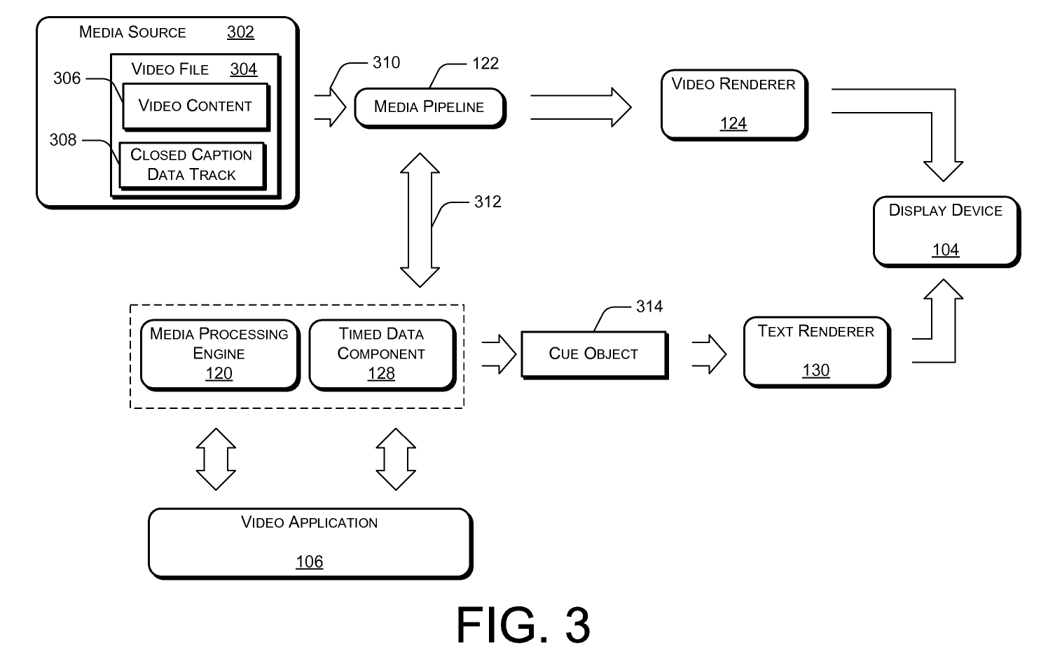

FIG. 3 illustrates an example data flow when a media source provides video content with in-band closed caption data as a track within a video content file. In the illustrated example, a video application 106 communicates with media processing engine 120 and timed data component 128 to identify media source 302. For example, a user may request, through a user interface of video application 106, to view a particular video content. The video application 106 sends the location of the requested video content to the media processing engine 120 and/or the timed data component 128 to identify the media source 302. A media source may be identified, for example, as a URL or a local file location. Alternatively, the video application 106 may download, access, or generate the video content, and provide the media processing engine 120 and timed data component 128 with a stream of data (e.g., media source 302). Media source 302 includes a video file 304, which includes multiple tracks. At least one track 306 includes video content, and at least one other track 308 includes closed caption data. Media pipeline 122 receives the video content and closed caption data tracks, as indicated by arrow 310. The video content 306 is processed in the media pipeline 122 and output to the video renderer 124, which prepares the video content for presentation via display device 104. Media pipeline 122 extracts the closed caption data track 308, and sends the closed caption data to the timed data component 128, as indicated by arrow 312.

Upon receiving the closed caption data 308, timed data component 128 determines the format of the closed caption data, performs the appropriate data parsing and data conversion, and generates cue object 314. Timed data component 128 sends the cue object 314 to the text renderer 130, which prepares the closed caption text for presentation via display device 104.

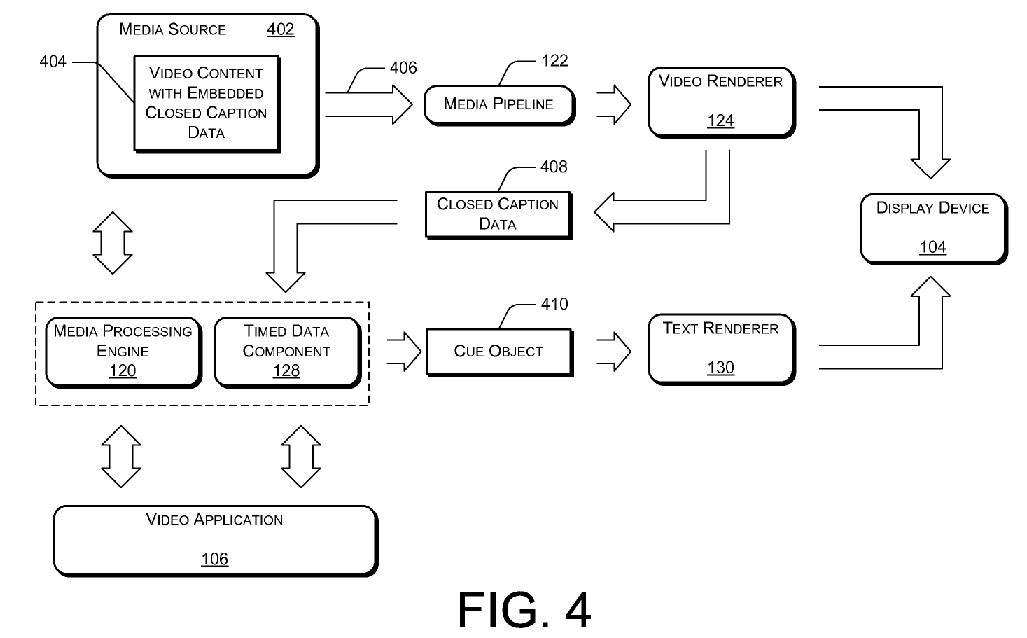

FIG. 4 illustrates an example data flow when a media source provides video content with embedded closed caption data within a video content file. In the illustrated example, a video application 106 communicates with media processing engine 120 to identify media source 402. For example, a user may request, through a user interface of video application 106, to view a particular video content. The video application 106 sends the location of the requested video content to the media processing engine 120 and/or the timed data component 128 to identify the media source 402. A media source may be identified, for example, as a URL or a local file location. Alternatively, the video application 106 may download, access, or generate the video content, and provide the media processing engine 120 and timed data component 128 with a stream of data (e.g., media source 302). Media source 402 includes a video content file 404, which includes embedded closed caption data. Media source 402 differs from media source 302 in that media source 302 includes separate tracks for video content and closed caption data. In contrast, in media source 402, the closed caption data is embedded within the frames of the video content. Media pipeline 122 receives the video content file 404, as indicated by arrow 406. The video content is processed in the media pipeline and output to the video renderer 124, which prepares the video content for presentation via display device 104. In preparing the video content for presentation, the video renderer 124 also identifies the embedded closed caption data 408, which the video renderer 124 sends to the timed data component 128.

Upon receiving the closed caption data 408, timed data component 128 determines the format of the closed caption data, performs the appropriate data parsing and data conversion, and generates cue object 410. Timed data component 128 sends the cue object 410 to the text renderer 130, which renders the closed caption text for presentation via display device 104.

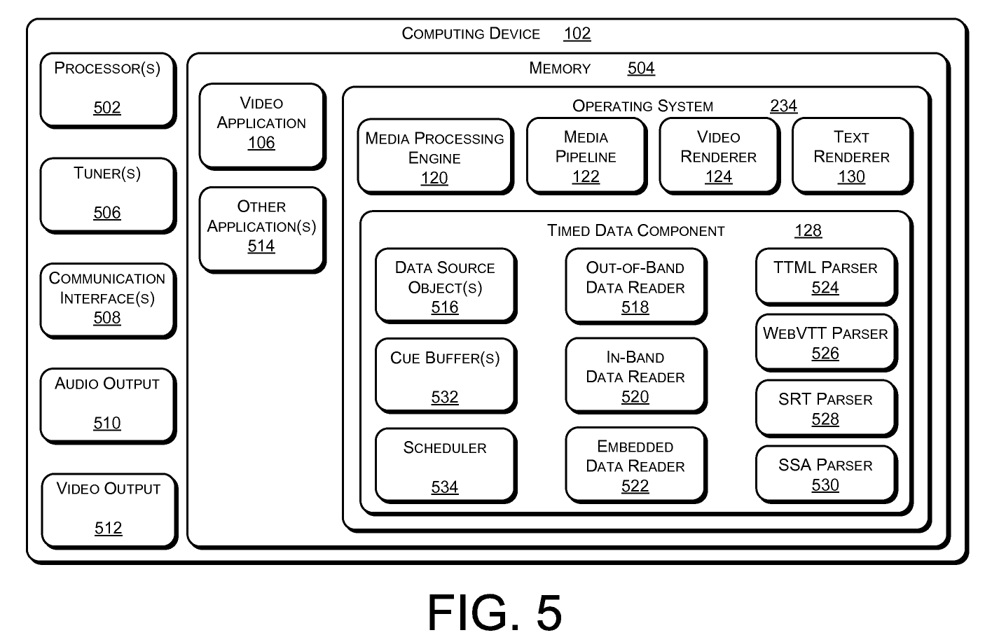

FIG. 5 illustrates select components of an example computing device 102, which includes timed data component 128. In the illustrated example, client device 102 includes one or more processor(s) 502, a memory 504, tuner(s) 506, communication interface(s) 508, audio output 510, and video output 512. Memory 504 may be implemented as any combination of various types of memory components. Examples of possible memory components include a random access memory (RAM), a disk drive, a mass storage component, and a non-volatile memory (e.g., ROM, Flash, EPROM, EEPROM, etc.). Alternative implementations of computing device 102 can include a range of processing and memory capabilities. For example, full-resource computing devices can be implemented with substantial memory and processing resources, including a disk drive to store content for replay by the viewer. Low-resource computing devices, however, may have limited processing and memory capabilities, such as a limited amount of RAM, no disk drive, and limited processing capabilities.

Processor(s) 502 process various instructions to control the operation of computing device 102 and to communicate with other electronic and computing devices. The memory 504 stores various information and/or data, including, for example, an operating system 134, a video application 106, and one or more other applications 514.

Tuner(s) 506 are representative of one or more in-band tuners that tune to various frequencies or channels to receive television signals, as well as an out-of-band tuner that tunes to a channel over which out-of-band data (e.g., closed caption data, metadata, etc.) is transmitted to computing device 102.

Communication interface(s) 508 enable computing device 102 to communicate with other computing devices, and represent other means by which computing device 102 may receive video content. For example, in an environment that supports transmission of video content over an IP network, communication interface 508 may represent a connection via which a video application (e.g., an Internet browser) can receive video content via a particular universal resource locator (URL).

Audio output 510 includes, for example, speakers, enabling computing device 102 to present audio content. In example implementations, audio output 510 provides signals to a television or other device that processes and/or presents or otherwise renders the audio data.

Video output 512 includes, for example, a display screen, enabling computing device 102 to present video content. In example implementations, video output 512 provides signals to a television or other display device that displays the video data.

Operating system 134, video application 106, and one or more other applications 514 are stored in memory 504 and executed on processor(s) 502. The video application 106 can include, for example, an Internet browser that includes video capabilities, a media player application, a video editing application, a video streaming application, a television viewing application, and so on.

Operating system 134 includes media processing engine 120, media pipeline 122, video renderer 124, text renderer 130, and timed data component 128. Media processing engine 120 controls communication between video application 106, media pipeline 122, and timed data component 128. Furthermore, media processing engine 120 drives the video processing performed within the media pipeline 122. In an example implementation, the media processing engine 120 acts as an intermediary, and simplifies communication between, the video application 106 and the media pipeline 122. For example, the video application 106 identifies the media source and instructs the media processing engine 120 to “play” the media source. From the perspective of the video application 106, the media source begins to play and the application may receive notification of events that describe the current playback state, such as, for example, “can play,” “playing,” “seeking,” or “ended.” However, while the media source is being played, additional processing and communication is being handled by the media processing engine 120 and the media pipeline, including, for example, identifying the proper bytestream to pull the data from (e.g., network bytestream or local file bytestream), iterating through available media source objects that can handle the type of content to be processed (e.g., mp4, avi, and so on), and reading how many and what type of streams are available based on what the media pipeline can support. In the described example implementation, the media pipeline 122 generates various events to be handled during playback of video content. Most of those events are handled by the media processing engine 120, simplifying the processing required by the video application 106.

Timed data component 128 includes data source object(s) 516, multiple timed data readers, such as out-of-band data reader 518, in-band data reader 520, and embedded data reader 522, multiple parsers, such as TTML parser 524, WebVTT parser 526, SRT parser 528, and SSA parser 530, cue buffer(s) 532, and scheduler 534.

Timed data component 128 creates a data source object 516 each time the timed data component 128 is notified of a new data source. For example, when video application 106 accesses video content through a website, video application 106 notifies timed data component 128, and timed data component 128 creates a new data source object 516 for data associated with the video content.

The data readers 518-522 read timed data and expose available tracks of timed data. For example, if the video content includes multiple in-band tracks of closed caption data (e.g., multiple languages), in-band data reader 520 reads the closed caption data from each of the closed caption tracks, buffers the closed caption data, and exposes multiple data streams, one associated with each of the closed caption tracks. The data source object 516 advertises to the video application 106 the data streams exposed by the data readers.

Based, for example, on input from a user, video application 106 may request to activate a particular closed caption data stream. In response, the data from the activated data stream is further processed within timed data component 128. For example, if the data is formatted in a format supported by the timed data component, the data is fed through the appropriate parser. For example, if the active data stream is formatted as TTML data, the data is fed through the TTML parser 524.

Each parser is configured to generate cue objects, which are then written to cue buffer(s) 532. Each cue object may include metadata, raw subtitle data, or text data. Each cue object may also include any combination of region data, style data, and/or timing data. Metadata may include, for example, raw binary data, such as ID3 data. Raw subtitle data includes, for example, raw binary data having an associated format, such as raw TTML data. Text data includes actual text content that is to be rendered along with the video content (e.g., closed caption text). Region data specifies a position on a display screen at which the text is to be displayed. Style data specifies any number of font and text properties to be applied to the text when the text is displayed. Timing data includes a start time and either an end time or a duration, relative to a time within the video content. The timing data enables the closed caption data to be synchronized for display at the correct time within the video content.

Scheduler 534 keeps track of timing data associated with the video content as the video content is being rendered. Scheduler 534 sends a cue from an active cue buffer when the timing data associated with the cue corresponds to the timing data of the video content being rendered.

Although shown separately, some of the components of computing device 102 may be implemented together in a single hardware device, such as in an application specific integrated circuit (ASIC). Additionally, a system bus (not shown) typically connects the various components within computing device 102. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Any of the components illustrated in FIG. 5 may be in hardware, software, or a combination of hardware and software. Further, any of the components illustrated in FIG. 5 may be implemented using any form of computer-readable media that is accessible by computing device 102, either locally or remotely, including over a network. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

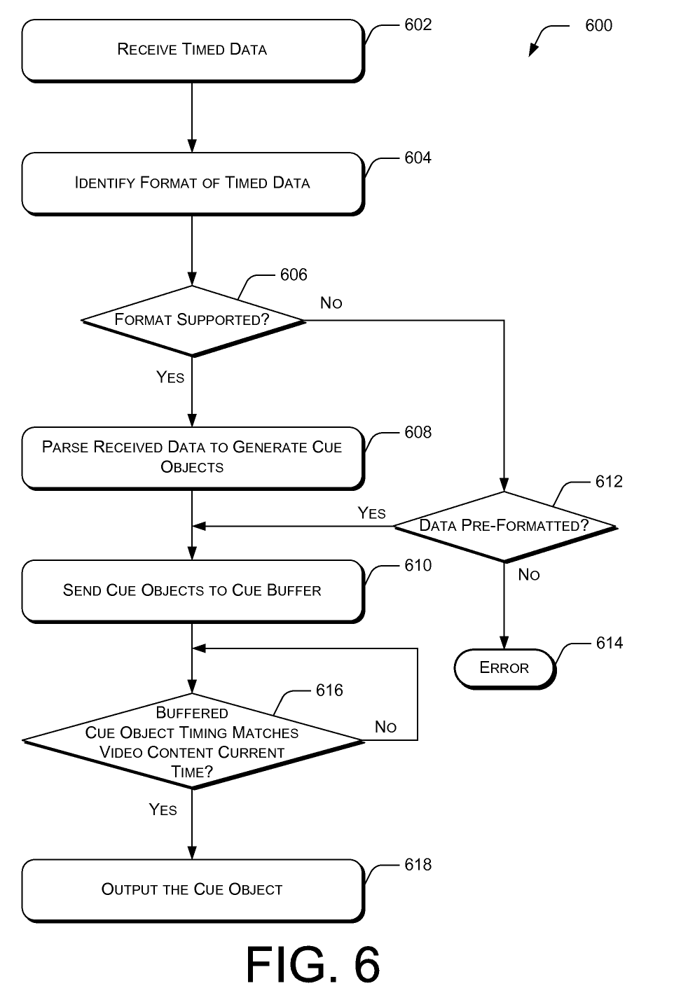

FIG. 6 illustrates an example method 600 for processing multi-format timed data. The method is illustrated as a set of operations shown as discrete blocks. The method may be implemented in any suitable hardware, software, firmware, or combination thereof. The order in which the operations are described is not to be construed as a limitation.

At block 602, timed data is received. For example, out-of-band reader 518, in-band reader 520, or embedded data reader 522 receives time data through a data source object 516.

At block 604, a format of the timed data is identified. For example, the timed data may include a format identifier that may be recognized by data reader 518, 520, or 522.

At block 606, timed data component 128 determines whether or not the format of the received timed data is supported. In other words, timed data component 128 determines whether or not time data component 128 includes a parser for the particular format.

If the format is supported (the “Yes” branch from block 606), then at block 608, the received data is parsed to generate one or more cue objects. For example, if the received data is in TTML format, then TTML parser 524 parses the data and generates one or more cue objects based on the data. As another example, if the received data is in WebVTT format, SRT format, or SSA format, then WebVTT parser, SRT parser, or SSA parser, respectively, parses the data and generates one or more cue objects based on the data.

At block 610, the parser sends the cue objects to a cue buffer 532.

On the other hand, if the format of the received data is not supported (the “No” branch from block 606), then at block 612, the timed data component 128 determines whether or not the received data is pre-formatted. For example, a video application 106 may utilize a proprietary closed caption format. In this scenario, video application 106 may include a custom parser, that converts the closed caption data to a format consistent with cue objects generated by the timed data component. The video application 106 may then send the timed data as pre-formatted cue objects to the timed data component.

If the received data is pre-formatted (the “Yes” branch from block 612), then at block 610, the data (in the form of cue objects) is sent to a cue buffer 532, bypassing the parsing described with reference to block 608.

If the format of the received data is not supported and the data is not pre-formatted (the “No” branch from block 612), then at block 614, an error message is generated.

At block 616, the timing data associated with the buffered cue object is compared to current timing data associated with the video content. For example, scheduler 534 tracks the current time of the video content being rendered, and compares the video content current time to the time data of cue objects in the cue buffers 532. This monitoring continues until the timing data of a cue object in the cue buffer matches the timing data of the video content being rendered.

When the timing data of a cue object in the cue buffer matches the timing data of the video content (the “Yes” branch from block 616), at block 618, the timed data component 128 outputs the cue object that has the matching timing information.

### Example Clauses

Paragraph A: A computing device comprising: at least one processor; a memory; and an operating system stored in memory and executable on the at least one processor, the operating system comprising: a video renderer configured to render video content for display via a display device; a timed data component configured to: parse timed data associated with the video content; generate a cue object based on the timed data; and output the cue object in accordance with timing information associated with the cue object corresponding with a current time of the video content being rendered; and a text renderer configured to: receive the cue object; and render for display via the display device, text associated with the received cue object, such that, the displayed text is synchronized with the video content.

Paragraph B: A computing device as Paragraph A recites, wherein the timing information associated with the cue object comprises: a start time; and a duration.

Paragraph C: A computing device as Paragraph A or Paragraph B recites, wherein the timed data includes closed caption text.

Paragraph D: A computing device as any of Paragraphs A-C recite, wherein the timed data component includes an out-of-band data reader configured to receive out-of-band timed data associated with the video content.

Paragraph E: A computing device as any of Paragraphs A-D recite, wherein the timed data component includes an in-band data reader configured to receive in-band timed data associated with the video content.

Paragraph F: A computing device as any of Paragraphs A-E recite, wherein the timed data component includes an embedded data reader configured to receive timed data embedded within the video content.

Paragraph G: A computing device as any of Paragraphs A-F recite, wherein the timed data component includes a plurality of timed data parsers.

Paragraph H: A computing device as Paragraph G recites, wherein the plurality of timed data parsers includes one or more of: a Timed Text Markup Language (TTML) parser; a Web Video Text Tracks (WebVTT) parser; a SubRip Text (SRT) parser; or a SubStation Alpha (SSA) parser.

Paragraph I: A computing device as any of Paragraphs A-H recite, wherein the timed data component includes a cue buffer configured to buffer the cue object until the timing information associated with the cue object corresponds with the current time of the video content being rendered.

Paragraph J: A computing device as any of Paragraphs A-I recite, wherein the timed data component includes a scheduler configured to: monitor timing data associated with the video content being rendered; and determine when the timing data associated with the cue object corresponds with the current time of the video content being rendered.

Paragraph K: A method comprising: receiving first closed caption data in a first format; converting the first closed caption data to a first cue object; sending the first cue object to a renderer, the renderer configured to render for display, first closed caption text described by the first closed caption data; receiving second closed caption data in a second format, the second format being different from the first format; converting the second closed caption data to a second cue object, a data structure of the first cue object being the same as a data structure of the second cue object; and sending the second cue object to the renderer, the renderer configured to render for display, second closed caption text described by the second closed caption data.

Paragraph L: A method as Paragraph K recites, wherein sending the first cue object to the renderer comprises: monitoring timing data associated with video content being rendered for display; and sending the first cue object to the renderer based on timing data associated with the first cue object corresponding with the timing data associated with the video content being rendered for display.

Paragraph M: A method as Paragraph K or Paragraph L recites, wherein the first format is one of: Timed Text Markup Language (TTML); Web Video Text Tracks (WebVTT); SubRip Text (SRT); or SubStation Alpha (SSA).

Paragraph N: A method as any of Paragraphs K-M recite, further comprising: receiving third closed caption data in a third format, the third format structured according to the data structure of the first cue object and the second cue object; generating, based on the received third closed caption data, a third cue object; and sending the third cue object to the renderer, the renderer configured to render for display, third closed caption text described by the third closed caption data.

Paragraph O: A method as any of Paragraphs K-M recite, further comprising: receiving timed metadata that includes metadata and timing information; generating, based on the received timed metadata, a third cue object, a data structure of the third cue object being the same as the data structure of the first cue object and the data structure of the second cue object; and outputting the third cue object in accordance with timing data associated with the third cue object corresponding with timing data of video content being rendered for display.

Paragraph P: One or more computer-readable media comprising computer-executable instructions that, when executed on a processor of a computing device, direct the computing device to: receive first video content; identify first timed data associated with the first video content; determine a format of the first timed data; select a first parser from a plurality of parsers, the first parser corresponding to the format of the first timed data; use the first parser to generate a first cue object that includes data and timing information extracted from the first timed data; monitor timing information associated with the first video content to determine a current time associated with the first video content, the current time being a time associated with a video frame that is currently being rendered for display; and output the first cue object in accordance with the current time associated with the first video content corresponding to the timing information of the first cue object.

Paragraph Q: One or more computer-readable media as Paragraph P recites, wherein identifying the first timed data associated with the first video content comprises at least one of: identifying a first data file associated with a second data file, wherein the first data file contains the first timed data and the second data file contains the first video content; identifying first and second tracks within a data file, the first track containing the first video content and the second track containing the first timed data; or receiving from a video renderer, the first timed data, the first timed data having been embedded within one or more frames of the first video content, the video renderer having extracted the first timed data from the one or more frames of the first video content.

Paragraph R: One or more computer-readable media as Paragraph P or Paragraph Q recites, wherein the data extracted from the first timed data comprises closed caption text.

Paragraph S: One or more computer-readable media as any of Paragraphs P-R recite, wherein the computer-executable instructions, when executed on the processor of the computing device, further direct the computing device to: receive second video content; identify second timed data associated with the second video content, the second timed data comprising one or more cue objects; extract from the second timed data, a second cue object that includes data and timing information, a data structure of the second cue object being the same as a data structure of the first cue object; monitor timing information associated with the second video content to determine a current time associated with the second video content, the current time being a time associated with a video frame that is currently being rendered for display; and output the second cue object in accordance with the current time associated with the second video content corresponding to the timing information of the second cue object.

Paragraph T: One or more computer-readable media as any of Paragraphs P-R recite, wherein the computer-executable instructions, when executed on the processor of the computing device, further direct the computing device to: receive second video content; identify second timed data associated with the second video content; determine a format of the second timed data, the format of the second timed data being different from the format of the first timed data; select a second parser from the plurality of parsers, the second parser corresponding to the format of the second timed data, the second parser being different from the first parser; use the second parser to generate a second cue object that includes data and timing information extracted from the second timed data, a data structure of the second cue object being the same as a data structure of the first cue object; monitor timing information associated with the second video content to determine a current time associated with the second video content, the current time being a time associated with a video frame that is currently being rendered for display; and output the second cue object in accordance with the current time associated with the second video content corresponding to the timing information of the second cue object.

### CONCLUSION

Although unified processing of multi-format timed data has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

The operations of the example process are illustrated in individual blocks and summarized with reference to those blocks. The process is illustrated as a logical flow of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described process can be performed by resources associated with one or more computing device(s) 102, such as one or more internal or external CPUs or GPUs, and/or one or more pieces of hardware logic such as FPGAs, DSPs, or other types of accelerators.

The methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

We claim:

1. A computing device comprising:
at least one processor;
a memory; and
an operating system stored in memory and executable on the at least one processor, the operating system comprising:
a video renderer configured to render video content for display via a display device;
a timed data component configured to:
parse timed data associated with the video content;
generate a cue object based on the timed data; and
output the cue object in accordance with timing information associated with the cue object corresponding with a current time of the video content being rendered; and
a text renderer configured to:
receive the cue object; and
render for display via the display device, text associated with the received cue object, such that, the displayed text is synchronized with the video content.

2. A computing device as recited in claim 1, wherein the timing information associated with the cue object comprises:
a start time; and
a duration.

3. A computing device as recited in claim 2, wherein the timed data includes closed caption text.

4. A computing device as recited in claim 1, wherein the timed data component includes an out-of-band data reader configured to receive out-of-band timed data associated with the video content.

5. A computing device as recited in claim 1, wherein the timed data component includes an in-band data reader configured to receive in-band timed data associated with the video content.

6. A computing device as recited in claim 1, wherein the timed data component includes an embedded data reader configured to receive timed data embedded within the video content.

7. A computing device as recited in claim 1, wherein the timed data component includes a plurality of timed data parsers.

8. A computing device as recited in claim 7, wherein the plurality of timed data parsers includes one or more of:
a Timed Text Markup Language (TTML) parser;
a Web Video Text Tracks (WebVTT) parser;
a SubRip Text (SRT) parser; or
a SubStation Alpha (SSA) parser.

9. A computing device as recited in claim 1, wherein the timed data component includes a cue buffer configured to buffer the cue object until the timing information associated with the cue object corresponds with the current time of the video content being rendered.

10. A computing device as recited in claim 1, wherein the timed data component includes a scheduler configured to:
monitor timing data associated with the video content being rendered; and
determine when the timing data associated with the cue object corresponds with the current time of the video content being rendered.

11. A method comprising:
receiving first closed caption data in a first format;
converting the first closed caption data to a first cue object;
sending the first cue object to a renderer, the renderer configured to render for display, first closed caption text described by the first closed caption data;
receiving second closed caption data in a second format, the second format being different from the first format;
converting the second closed caption data to a second cue object, a data structure of the first cue object being the same as a data structure of the second cue object; and
sending the second cue object to the renderer, the renderer configured to render for display, second closed caption text described by the second closed caption data.

12. A method as recited in claim 11, wherein sending the first cue object to the renderer comprises:
monitoring timing data associated with video content being rendered for display; and
sending the first cue object to the renderer based on timing data associated with the first cue object corresponding with the timing data associated with the video content being rendered for display.

13. A method as recited in claim 11, wherein the first format is one of:
Timed Text Markup Language (TTML);
Web Video Text Tracks (WebVTT);
SubRip Text (SRT); or
SubStation Alpha (SSA).

14. A method as recited in claim 11, further comprising:
receiving third closed caption data in a third format, the third format structured according to the data structure of the first cue object and the second cue object;
generating, based on the received third closed caption data, a third cue object; and
sending the third cue object to the renderer, the renderer configured to render for display, third closed caption text described by the third closed caption data.

15. A method as recited in claim 11, further comprising:
receiving timed metadata that includes metadata and timing information;
generating, based on the received timed metadata, a third cue object, a data structure of the third cue object being the same as the data structure of the first cue object and the data structure of the second cue object; and
outputting the third cue object in accordance with timing data associated with the third cue object corresponding with timing data of video content being rendered for display.

16. One or more computer-readable media comprising computer-executable instructions that, when executed on a processor of a computing device, direct the computing device to:
receive first video content;
identify first timed data associated with the first video content;
determine a format of the first timed data;
select a first parser from a plurality of parsers, the first parser corresponding to the format of the first timed data;
use the first parser to generate a first cue object that includes data and timing information extracted from the first timed data;
monitor timing information associated with the first video content to determine a current time associated with the first video content, the current time being a time associated with a video frame that is currently being rendered for display; and
output the first cue object in accordance with the current time associated with the first video content corresponding to the timing information of the first cue object.

17. One or more computer-readable media as recited in claim 16, wherein identifying the first timed data associated with the first video content comprises at least one of:
identifying a first data file associated with a second data file, wherein the first data file contains the first timed data and the second data file contains the first video content;
identifying first and second tracks within a data file, the first track containing the first video content and the second track containing the first timed data; or
receiving from a video renderer, the first timed data, the first timed data having been embedded within one or more frames of the first video content, the video renderer having extracted the first timed data from the one or more frames of the first video content.

18. One or more computer-readable media as recited in claim 16, wherein the data extracted from the first timed data comprises closed caption text.

19. One or more computer-readable media as recited in claim 16, wherein the computer-executable instructions, when executed on the processor of the computing device, further direct the computing device to:
receive second video content;
identify second timed data associated with the second video content, the second timed data comprising one or more cue objects;
extract from the second timed data, a second cue object that includes data and timing information, a data structure of the second cue object being the same as a data structure of the first cue object;
monitor timing information associated with the second video content to determine a current time associated with the second video content, the current time being a time associated with a video frame that is currently being rendered for display; and
output the second cue object in accordance with the current time associated with the second video content corresponding to the timing information of the second cue object.

20. One or more computer-readable media as recited in claim 16, wherein the computer-executable instructions, when executed on the processor of the computing device, further direct the computing device to:
receive second video content;
identify second timed data associated with the second video content;
determine a format of the second timed data, the format of the second timed data being different from the format of the first timed data;
select a second parser from the plurality of parsers, the second parser corresponding to the format of the second timed data, the second parser being different from the first parser;
use the second parser to generate a second cue object that includes data and timing information extracted from the second timed data, a data structure of the second cue object being the same as a data structure of the first cue object;
monitor timing information associated with the second video content to determine a current time associated with the second video content, the current time being a time associated with a video frame that is currently being rendered for display; and
output the second cue object in accordance with the current time associated with the second video content corresponding to the timing information of the second cue object.
